(19) United States
(12) Patent Application Publication
(10) Pub. No.: US 2015/0095279 A1
(43) Pub. Date: Apr. 2, 2015

(54) DATA ANALYTICS FOR OILFIELD DATA REPOSITORIES

(71) Applicant: SCHLUMBERGER TECHNOLOGY CORPORATION, Sugar Land, TX (US)

(72) Inventors: Hallgrim Ludvigsen, Stavanger (NO); Trond Benum, Trondheim (NO); Floyd Louis Broussard, III, The Woodlands, TX (US); Olav Lindtjorn, Katy, TX (US)

(21) Appl. No.: 14/497,970

(22) Filed: Sep. 26, 2014

Related U.S. Application Data
(60) Provisional application No. 61/883,661, filed on Sep. 27, 2013.

(51) Int. Cl. G06F 17/30

(52) U.S. Cl. CPC G06F 17/30536; G06F 17/30589
USPC 707/603

(57) ABSTRACT

A method for field management includes analyzing exploration and production (E&P) data sets to generate digital fingerprints of the E&P data sets. Each of the digital fingerprints represents a statistical characteristic of an E&P data set. The method further includes augmenting, by a computer processor, data set indices of the E&P data sets based on the digital fingerprints to generate augmented data set indices, retrieving, in response to a user search input and using the augmented data set indices, a selected E&P data set from the E&P data sets, and presenting the selected E&P data set.

### CROSS REFERENCE TO RELATED APPLICATIONS

This application claims benefit under 35 U.S.C. §119(e) of U.S. Provisional Patent Application No. 61/883,661, filed on Sep. 27, 2013, and entitled “Data Analytics for Oilfield Data Repositories,” which is hereby incorporated by reference.

### BACKGROUND

Operations, such as geophysical surveying, drilling, logging, well completion, and production, may be performed to locate and gather valuable downhole fluids. The subterranean assets are not limited to hydrocarbons such as oil, throughout this document, the terms “oilfield” and “oilfield operation” may be used interchangeably with the terms “field” and “field operation” to refer to a site where any type of valuable fluids or minerals can be found and the activities required to extract them. The terms may also refer to sites where substances are deposited or stored by injecting the substances into the surface using boreholes and the operations associated with this process. Further, the term “field operation” refers to a field operation associated with a field, including activities related to field planning, wellbore drilling, wellbore completion, and/or production using the wellbore.

After oil and gas wells are drilled and hydrocarbon production begins, engineers are responsible for maintaining oil and gas production. One of the challenges faced by oil and gas engineers is to analyze the production system (reservoir, well, choke, flow line) using available measurement data to interpret the root cause for declining production system performance, such as a decline in hydrocarbon flow rate.

### SUMMARY

In general, in one aspect, embodiments relate to a method for field management. The method includes analyzing exploration and production (E&P) data sets to generate digital fingerprints of the E&P data sets. Each of the digital fingerprints represents a statistical characteristic of an E&P data set. The method further includes augmenting, by a computer processor, data set indices of the E&P data sets based on the digital fingerprints to generate augmented data set indices, retrieving, in response to a user search input and using the augmented data set indices, a selected E&P data set from the E&P data sets, and presenting the selected E&P data set.

Other aspects of data analytics for oilfield data repositories will be apparent from the following detailed description and the appended claims.

### BRIEF DESCRIPTION OF DRAWINGS

The appended drawings illustrate several embodiments of data analytics for oilfield data repositories and are not to be considered limiting of its scope, for data analytics for oilfield data repositories may admit to other equally effective embodiments.

FIG. 1.1 is a schematic view, partially in cross-section, of a field in which one or more embodiments of data analytics for oilfield data repositories may be implemented.

FIG. 1.2 shows an exploration and production (E&P) computer system in accordance with one or more embodiments.

FIGS. 2.1 and 2.2 show flowcharts of a method for data analytics for oilfield data repositories in accordance with one or more embodiments.

FIG. 3 depicts a computer system using which one or more embodiments of data analytics for oilfield data repositories may be implemented.

### DETAILED DESCRIPTION

Aspects of the present disclosure are shown in the above-identified drawings and described below. In the description, like or identical reference numerals are used to identify common or similar elements. The drawings are not necessarily to scale and certain features may be shown exaggerated in scale or in schematic in the interest of clarity and conciseness.

In general, embodiments are directed to field management of a field. Specifically, one or more embodiments generate digital fingerprints of exploration and production (E&P) data sets and augment data set indices with the digital fingerprints. Each of the digital fingerprints represents a statistical characteristic of an E&P data set. Using the augmented data set indices and in response to a user search input, one or more embodiments may retrieve a selected E&P data set.

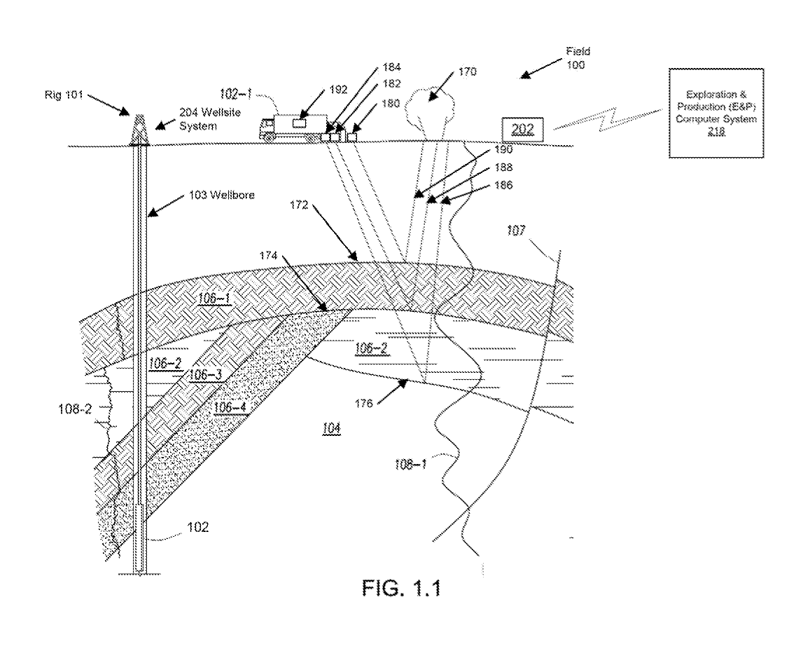

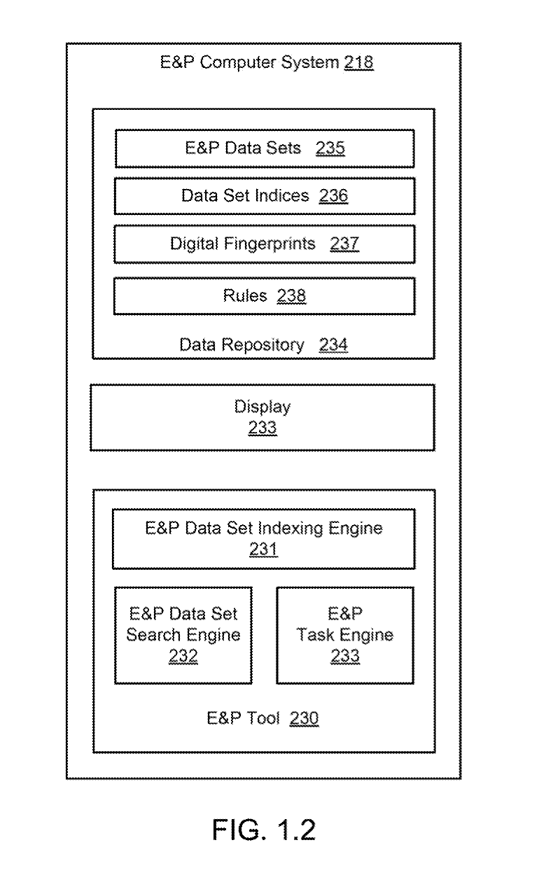

FIG. 1.1 depicts a schematic view, partially in cross section, of a field (100) in which one or more embodiments of data analytics for oilfield data repositories may be implemented. In one or more embodiments, one or more of the modules and elements shown in FIG. 1.1 may be omitted, repeated, and/or substituted. Accordingly, embodiments of data analytics for oilfield data repositories should not be considered limited to the specific arrangements of modules shown in FIG. 1.1.

As shown in FIG. 1.1, the subterranean formation (104) includes several geological structures (106-1 through 106-4). As shown, the formation has a sandstone layer (106-1), a limestone layer (106-2), a shale layer (106-3), and a sand layer (106-4). A fault line (107) extends through the formation. In one or more embodiments, various survey tools and/or data acquisition tools disposed throughout the field are adapted to measure the formation and detect the characteristics of the geological structures of the formation. As noted above, the outputs of these various survey tools and/or data acquisition tools, as well as data derived from analyzing the outputs, are considered as part of the historic information.

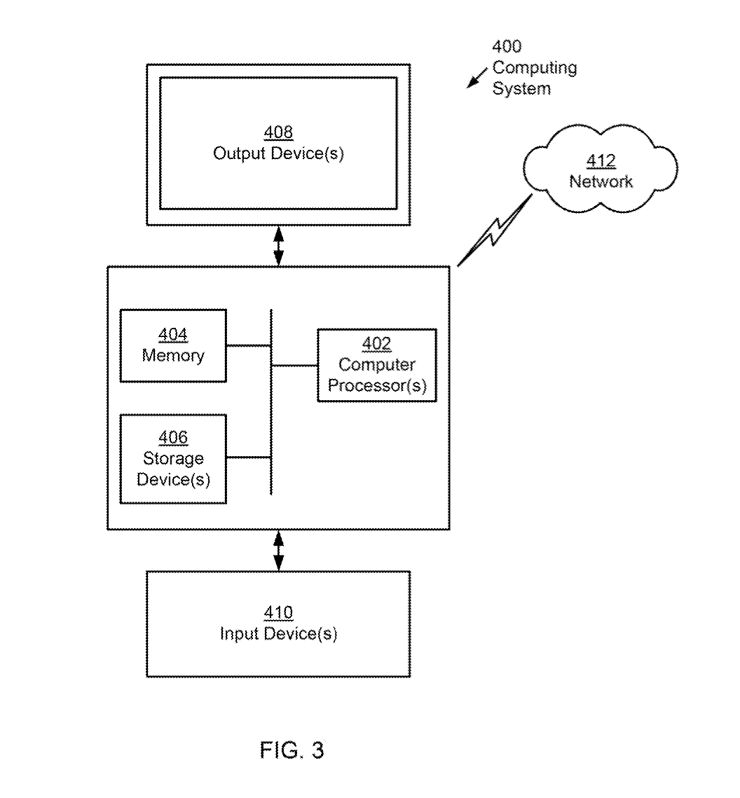

As shown in FIG. 1.1, seismic truck (102-1) represents a survey tool that is adapted to measure properties of the subterranean formation in a seismic survey operation based on sound vibrations. One such sound vibration (e.g., 186, 188, 190) generated by a source (170) reflects off a plurality of horizons (e.g., 172, 174, 176) in the subterranean formation (104). Each of the sound vibrations (e.g., 186, 188, 190) are received by one or more sensors (e.g., 180, 182, 184), such as geophone-receivers, situated on the earth's surface. The geophones produce electrical output signals, which may be transmitted, for example, as input data to a computer (192) on the seismic truck (102-1). Responsive to the input data, the computer (192) may generate a seismic data output, which may be logged and provided to a surface unit (202) by the computer (192) for further analysis. The computer (192) may be the computer system shown and described in relation to FIG. 3.

Further as shown in FIG. 1.1, the wellsite system (204) is associated with a rig (101), a wellbore (103), and other wellsite equipment and is configured to perform wellbore operations, such as logging, drilling, fracturing, production, or other applicable operations. Generally, survey operations and wellbore operations are referred to as field operations of the field (100). These field operations may be performed as directed by the surface unit (202).

In one or more embodiments, the surface unit (202) is operatively coupled to the computer (192) and/or a wellsite system (204). In particular, the surface unit (202) is configured to communicate with the computer (192) and/or the data acquisition tool (102) to send commands to the computer (192) and/or the data acquisition tools (102) and to receive data therefrom. For example, the data acquisition tool (102) may be adapted for measuring downhole properties using logging-while-drilling (“LWD”) tools. In one or more embodiments, surface unit (202) may be located at the wellsite system (204) and/or remote locations. The surface unit (202) may be provided with computer facilities for receiving, storing, processing, and/or analyzing data from the computer (192), the data acquisition tool (102), or other part of the field (104). The surface unit (202) may also be provided with or functionally for actuating mechanisms at the field (100). The surface unit (202) may then send command signals to the field (100) in response to data received, for example to control and/or optimize various field operations described above.

In one or more embodiments, the data received by the surface unit (202) represents characteristics of the subterranean formation (104) and may include seismic data and/or information related to porosity, saturation, permeability, natural fractures, stress magnitude and orientations, elastic properties, etc. during a drilling, fracturing, logging, or production operation of the wellbore (103) at the wellsite system (204). For example, data plot (108-1) may be a seismic two-way response time or other types of seismic measurement data. In another example, data plot (108-2) may be a wireline log, which is a measurement of a formation property as a function of depth taken by an electrically powered instrument to infer properties and make decisions about drilling and production operations. The record of the measurements (e.g., on a long strip of paper) may also be referred to as a log. Measurements obtained by a wireline log may include resistivity measurements obtained by a resistivity measuring tool. In yet another example, the data plot (108-2) may be a plot of a dynamic property, such as the fluid flow rate over time during production operations. Those skilled in the art will appreciate that other data may also be collected, such as, but not limited to, historical data, user inputs, economic information, other measurement data, and other parameters of interest.

In one or more embodiments, the surface unit (202) is communicatively coupled to an exploration and production (E&P) computer system (218). In one or more embodiments, the data received by the surface unit (202) may be sent to the E&P computer system (218) for further analysis. Generally, the E&P computer system (218) is configured to analyze, model, control, optimize, or perform management tasks of the aforementioned field operations based on the data provided from the surface unit (202). In one or more embodiments, the E&P computer system (218) includes the functionality for manipulating and analyzing the data, such as performing seismic interpretation or borehole resistivity image log interpretation to identify geological surfaces in the subterranean formation (104) or performing simulation, planning, and optimization of production operations of the wellsite system (204). In one or more embodiments, the result generated by the E&P computer system (218) may be displayed for user viewing using a two-dimensional (2D) display, three-dimensional (3D) display, or other suitable displays. Although the surface unit (202) is shown as separate from the E&P computer system (218) in FIG. 1.1, in other examples, the surface unit (202) and the E&P computer system (218) may also be combined.

FIG. 1.2 shows more details of the E&P computer system (218) in which one or more embodiments of data analytics for oilfield data repositories may be implemented. In one or more embodiments, one or more of the modules and elements shown in FIG. 1.2 may be omitted, repeated, and/or substituted. Accordingly, embodiments of data analytics for oilfield data repositories should not be considered limited to the specific arrangements of modules shown in FIG. 1.2.

As shown in FIG. 1.2, the E&P computer system (218) includes an E&P tool (230), a display (233), and a data repository (234). In one or more embodiments, the data repository (234) may be distributed and residing on separate nodes of the E&P computer system (218). In one or more embodiments, the data repository (234) is coupled to the computer processor executing the E&P tool (230) and configured to store the E&P data sets (235), the data set indices (236), the digital fingerprints (237), and the rules (238). In addition, the E&P tool (230) includes an E&P data set indexing engine (231), an E&P data set search engine (232), and a task engine (233). Each of these elements is described below.

In one or more embodiments, the E&P data sets (235) are associated with field objects in the field. A field object is any physical object in the field, such as a geological structure, a wellsite or a component of the wellsite (e.g., wellbore, drill, drillstring, etc.), or other types of object described in reference to FIG. 1.1 above. Each field object has a number of attributes depending on the type of the field object. For example, the attribute of a geological structure may include physical, chemical, geological properties, and/or other descriptions of the geological structure. In another example, the attribute of a well may include physical, chemical, and geological properties of the surrounding formation, and/or information related to the drilling, production, or other descriptions of the well. Each of the E&P data sets (235) includes information (e.g., measurements, modeled values, parameters, and other information) regarding one or more attributes of a field object. In one or more embodiments, at least a portion of the E&P data sets (235) are associated with geological structures and wells, and are obtained using acquisition tools shown in FIG. 1.1 above. For example, the subterranean formation characteristics associated with a geological structure may be organized as a seismic data set of the geological structure. In another example, downhole properties of a well may be organized as a wireline log of the well. The seismic data set and the wireline log are examples of the E&P data sets.

In one or more embodiments, each digital fingerprint is an alphanumeric string that represents statistical characteristics of a corresponding E&P data set, where the statistical characteristics correlate to a condition of the field object associated with the E&P data set. In particular, the digital fingerprint is a machine readable alphanumeric string that is not human readable. In one or more embodiments, each of the rules (238) specifies an empirical statistic found in at least a portion of the E&P data sets (235), wherein each field object associated with each E&P data set in the portion exhibits a pre-determined condition. Specifically, each of the rules (238) identifies a correlation between the empirical statistic and the pre-determined condition. In one or more embodiments, the empirical statistic includes a statistical pattern of an attribute for field objects associated with the portion of the E&P data sets (235). In one or more embodiments, the empirical statistic includes a statistical pattern of digital fingerprints of the portion of the E&P data sets (235). Examples of the data set indices (236), digital fingerprints (237), and rules (238) are described in reference to TABLES 1 and 2 below.

Indexing is the act of describing or classifying an E&P data set (e.g., one of the E&P data sets (235)) by one or more indices (e.g., data set indices (236)) to represent the content of the E&P data set. The data set indices (236) may be organized as an index of the E&P data sets (235), where each of the data set indices (236) is referred to as an index entry. Indexing the E&P data set increases the searchability of the E&P data set among the E&P data sets (235). In one or more embodiments, each E&P data set of the E&P data sets (235) is indexed by extracting a data item from the E&P data set or by assigning a data item from a pre-determined vocabulary to the E&P data set. The extracted or assigned data item is included in the index as an index entry of the E&P data set. In one or more embodiments, the index entry may include a human readable word/phrase, or a machine readable alphanumeric string that is not human readable.

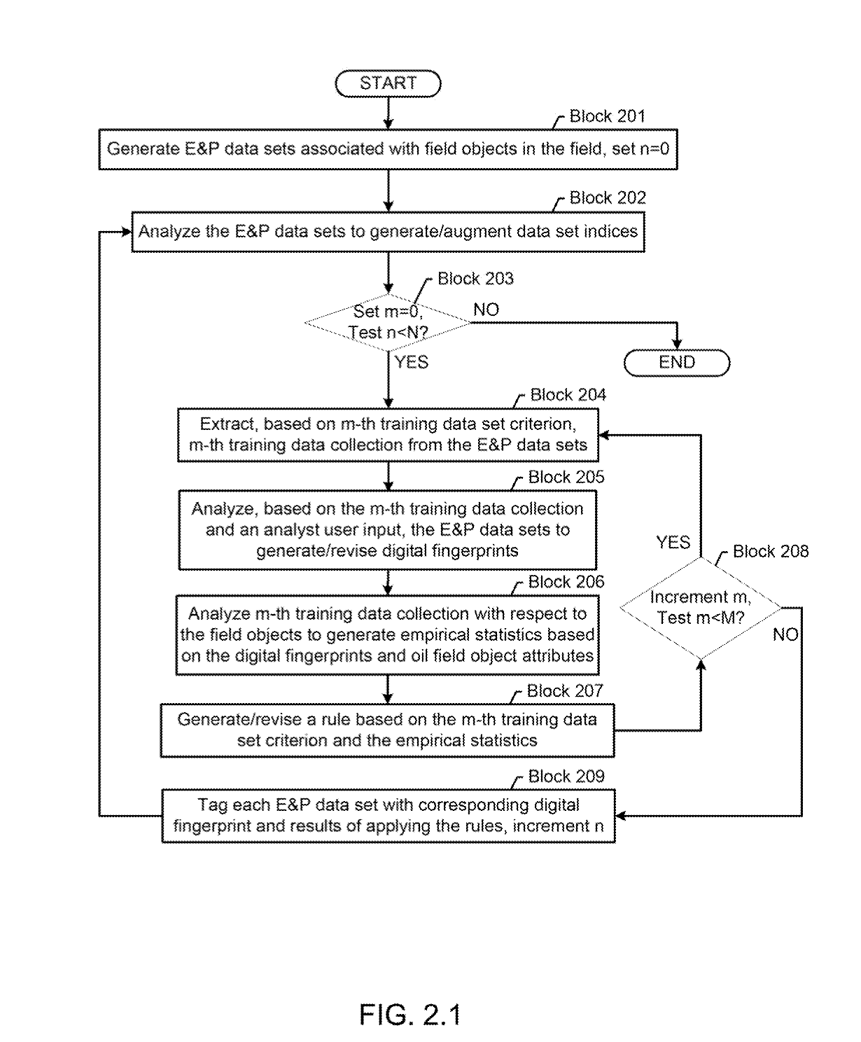

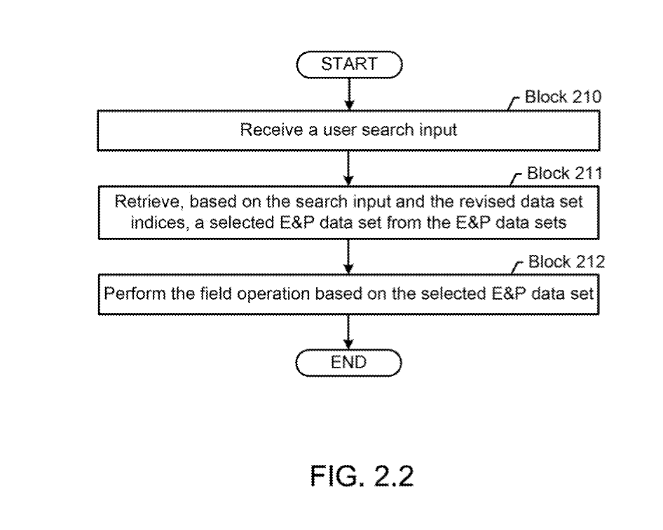

In one or more embodiments, the E&P data set indexing engine (231) is configured to analyze the E&P data sets (235) to generate data set indices (236) for the E&P data sets (235). In addition, the E&P data set indexing engine (231) is configured to further analyze the E&P data sets (235) to generate digital fingerprints (237) and rules (238) of the E&P data sets (235). In one or more embodiments, the data set indices (236) are revised/augmented based on these digital fingerprints (237) and rules (238) to generate a revised/augmented version of the data set indices (237). For example, each data set index (i.e., one of the data set indices (236)) may be tagged with a digital fingerprint (i.e., one of the digital fingerprints (237)) of a corresponding E&P data set (i.e., one of the E&P data sets (235)). In another example, each data set index (i.e., one of the data set indices (236)) may be tagged with a result of applying a rule (i.e., one of the rules (238)) to a corresponding E&P data set (i.e., one of the E&P data sets (235)). Prior to any revision/augmentation, the data set indices (236) includes initial data set indices. Subsequent to the revision/augmentation, a data set index in the revised/augmented version of the data set indices (237) includes an initial data set index and the tagged digital fingerprint and/or the tagged result of applying the rule. In one or more embodiments, the tagged digital fingerprint and/or the tagged result of applying the rule are stored in the data set indices (236) as metadata. In one or more embodiments, the data set indices (236) are revised/augmented in multiple iterations using the method described in reference to FIG. 2.1 below.

In one or more embodiments, the E&P data set search engine (232) is configured to retrieve a selected E&P data set from the E&P data sets (235). Specifically, the selected E&P data set is retrieved in response to a user search input and is retrieved using the revised/augmented version of the data set indices (237). In one or more embodiments, the E&P data set search engine (232) is configured to compare the user search input and the revised/augmented version of data set indices (237) to identify the selected E&P data set. Examples of retrieving a selected E&P data set from the E&P data sets (235) are described in reference to TABLES 1 and 2 below.

In one or more embodiments, the E&P task engine (233) is configured to perform the field operation based on the selected E&P data set. Specifically, the field operation is an operation performed at a field, such as the survey operations and wellbore operations described in reference to FIG. 1.1 above.

In one or more embodiments, the E&P tool (230) uses the method described in reference to FIGS. 2.1 and 2.2 below to retrieve the selected E&P data set for performing the field operation.

FIGS. 2.1 and 2.2 show method flowcharts in accordance with one or more embodiments of data analytics for oilfield data repositories. In one or more embodiments, the method of FIGS. 2.1 and 2.2 may be practiced using the E&P computer system (218) described in reference to FIG. 1.2 above. In one or more embodiments, one or more of the blocks shown in FIGS. 2.1 and 2.2 may be omitted, repeated, and/or performed in a different order than that shown in FIGS. 2.1 and 2.2. Accordingly, the specific arrangement of Blocks shown in FIGS. 2.1 and 2.2 should not be construed as limiting the scope of data analytics for oilfield data repositories.

FIG. 2.1 shows a flowchart for generating data set indices for E&P data sets. Initially, in Block 201, the E&P data sets associated with field objects (e.g., geological structures and wells in the field) are generated. In one or more embodiments, subterranean formation characteristics and downhole properties of wells are obtained using acquisition tools shown in FIG. 1.1 above. Accordingly, the outputs of the acquisition tools are organized into the E&P data sets. Further, an iteration count denoted as “n” is initialized to 0. Specifically, the iteration count “n” represents the number of iterations that the data set indices of the E&P sets have been generated and/or augmented in Blocks 202 through Block 209.

In Block 202, the E&P data sets of the field objects are analyzed to generate data set indices representing the E&P data sets. In particular, the data set indices facilitate searching the E&P data sets based on a user search input that contains one or more search words. In one or more embodiments, the search words are human readable. In one or more embodiments, the data set indices are generated using a search engine indexing algorithm. In one or more embodiments, the data set indices are generated from existing data source attributes, arrays, calculated values and images.

In Block 203, a training data collection count denoted as “m” is initialized to 0. Specifically, the training data collection count “m” represents the number of various training data collection criteria that have been used to extract corresponding training data collections in Blocks 204 through Block 207.

Further, a determination is made as to whether the iteration count “n” is less than a pre-determined maximum count “N”. Specifically, “N” represents the total number of iterations that the data set indices of the E&P sets are to be generated and/or augmented in Blocks 202 through Block 209. For example, the pre-determined maximum count “N” may be any non-zero positive integer, such as 1, 2, 10, etc. If the determination is negative, i.e., the iteration count “n” is not less than the pre-determined maximum count “N”, the method ends. If the determination is positive, i.e., the iteration count “n” is less than the pre-determined maximum count “N”, the method proceeds to Block 204.

In Block 204, based on a m-th training data collection criterion, a portion of the E&P data sets is extracted as a m-th training data collection. In one or more embodiments, the m-th training data collection criterion includes a pre-determined condition (e.g., a field phenomenon, a physical, chemical, or geological property value, etc.), exhibited by field objects associated with E&P data sets in the m-th training data collection. For example, the m-th training data collection criterion may specify a water kick phenomenon of a well, and the m-th training data collection includes E&P data sets of wells that are known to exhibit the water kick phenomenon.

In Block 205, the E&P data sets are analyzed to generate a digital fingerprint of each E&P data set. In one or more embodiments, the E&P data sets are analyzed using a fingerprint algorithm to generate digital fingerprints of the E&P data sets. In one or more embodiments, the fingerprint algorithm is configured to generate the digital fingerprints that correlate with the m-th training data collection criterion. For example, the digital fingerprints generated from the E&P data sets of wells that are known to exhibit the water kick phenomenon are similar to each other, and are distinct from other digital fingerprints generated from other E&P data sets of wells that are known to be without the water kick phenomenon. The digital fingerprint is generated by reducing a large dataset into a concise numerical representation that identifies aspects of the dataset.

In one or more embodiments, an analyst user input is received to select the fingerprint algorithm from a collection of fingerprint algorithms. In particular, the analyst user input is received from an analyst user based on the m-th training data collection criterion of the m-th training data collection. The use of the term criterion may include multiple criteria. Specifically, the analyst user is a user deemed to have more knowledge of the E&P data sets and/or the training data collection criterion, than other users. In one or more embodiments, the analyst user selects the fingerprint algorithm such that digital fingerprints of E&P data sets in the m-th training data collection are similar to each other, as compared to other digital fingerprints of other E&P data sets not included in the m-th training data collection. Accordingly, the digital fingerprint is a suitable indicator of whether the corresponding field object exhibits the pre-determined condition specified in the m-th training data collection criterion.

In one or more embodiments, for each iteration of Blocks 204 through 207, a different analyst user input may be received to select a different fingerprint algorithm that is suitable for the m-th training data collection criterion. Accordingly, multiple digital fingerprints may be generated for each E&P data set corresponding to multiple training data collection criteria. For example, in the iteration where the training data collection criterion relates to water kick phenomenon of a well, the resultant digital fingerprints of E&P data sets correlate with water kick phenomena of corresponding wells. In another example, in a different iteration where the training data collection criterion relates to a seismic characteristics of geological structures, the resultant digital fingerprints of E&P data sets correlate with the seismic characteristics of corresponding geological structures.

In Block 206, the m-th training data collection is analyzed with respect to the field objects to generate empirical statistic of the m-th training data collection. In one or more embodiments, the empirical statistic is extracted based on an attribute associated with each field object. Specifically, a statistical pattern of the attribute for the field objects included in the m-th training data collection is extracted as the empirical statistic. In particular, the statistical pattern is a mathematical property (e.g., minimum, maximum, median, standard deviation, centroid, etc.) of a statistical distribution (e.g., histogram, cluster diagram, etc.) of attribute values of the field objects. For example, the empirical statistic may include a well pressure threshold of wells exhibiting the water kick phenomenon. In another example, the empirical statistic may include a well pressure threshold or mud viscosity increase of wells exhibiting the water kick phenomenon. In one or more embodiments, the empirical statistic is extracted based on digital fingerprints of the E&P data sets. Specifically, a statistical pattern of the digital fingerprints for the E&P data sets included in the m-th training data collection is extracted as the empirical statistic. For example, the empirical statistic may include a common substring of the digital fingerprints of the E&P data sets associated with wells exhibiting the water kick phenomenon.

In Block 207, a rule is generated based on the empirical statistic of the m-th training data collection. In one or more embodiments, the rule specifies the correlation between the m-th training data collection criterion and the empirical statistic generated based on the m-th training data collection criterion. For example, the rule may specify the correlation or cause-effect relationship between the pre-determined field object condition (as specified in the m-th training data collection criterion) and the statistical pattern (of the field object attribute or the digital fingerprint). In other words, the rule is generated based on the empirical statistic indicating that field objects having one or more common attributes exhibit the pre-determined field object condition, while field objects not having the one or more attributes do not exhibit the condition.

In Block 208, the training data collection count “m” is incremented by one, and a determination is made as to whether “m” is less than a pre-determined maximum count “M”. Specifically, “M” represents the total number of various training data collection criteria to be used to extract corresponding training data collections in Blocks 204 through Block 207. For example, the pre-determined maximum count “M” may be any non-zero positive integer, such as 1, 2, 10, etc. If the determination is positive, i.e., the training data collection count “m” is less than the pre-determined maximum count “M”, the method returns to Block 204 for another iteration of generating additional digital fingerprints and an additional rule. If the determination is negative, i.e., the training data collection count “m” is not less than the pre-determined maximum count “M”, the method proceeds to Block 209.

In Block 209, the E&P data sets are augmented. In one or more embodiments, the E&P data sets are augmented by tagging each E&P data set with the corresponding digital fingerprint that is generated/revised in Block 205. In one or more embodiments, the E&P data sets are augmented by tagging each E&P data set with the a corresponding result of applying, to the E&P data set the rule that is generated/revised in Block 205. Once the E&P data sets are augmented, the iteration count “n” is incremented by one before returning to Block 202 to augment the data set indices based on the augmented E&P data sets. In one or more embodiments, a data set index in the augmented version of the data set indices includes an initial data set index and the tagged digital fingerprint and/or the tagged result of applying the rule. In one or more embodiments, a data set index in the augmented version of the data set indices may include other variations of the initial data set index and the tagged digital fingerprint and/or the tagged result of applying the rule.

Examples of generating the digital fingerprints and one or more rules to augment the E&P data sets and the corresponding data set indices are described in reference to TABLES 1 and 2 below.

FIG. 2.2 shows a flowchart for performing a field operation by retrieving an E&P data set from a collection of E&P data sets in response to a user search input. In one or more embodiments, prior to the user search input, the collection of E&P data sets have been analyzed using the method described in reference to FIG. 2.1 above to generate the augmented data set indices.

In Block 210, the user search input is received. In one or more embodiments, the user search input includes one or more human readable words or phrases describing what the user is searching for from a collection of E&P data sets. For example, the user may be searching for information relating to a particular condition of the field objects associated with the E&P data sets. In particular, the user may have less knowledge of the E&P data sets and/or the particular condition of the field objects, than the aforementioned analyst user.

In Block 211, in response to the user search input and using the augmented data set indices, a selected E&P data set is identified and retrieved from the collection of E&P data sets. In one or more embodiments, the user search input and the augmented data set indices are compared to find a matching data set index entry. Accordingly, the E&P data set corresponding to the matching data set index entry is selected and retrieved as the search result. For example, the user search input and the augmented data set indices may be compared based on keyword matching or semantic analysis.

Although not shown in FIG. 2.2, after the retrieval, the selected E&P data set may be presented. The presenting of the selected E&P dataset may be to transmit the selected E&P dataset to another device or to display the selected E&P dataset. The displaying of the selected E&P dataset may be direct or indirect. For example, the selected E&P dataset may be displayed as a whole, transformed into graphs or images, used for calculations and then the calculated results displayed, or otherwise displayed. Further, the display may be on a display device, printed, transmitted to a computing device for display, or otherwise displayed.

In Block 212, the field operation is performed based on the selected E&P data set. For example, the selected E&P data set may include historical information (e.g., drilling or production history) of a field object (e.g., a production well) that is similar to a target entity (e.g., a planned well) of the field operation (e.g, drilling operation). Accordingly, drilling or production planning of the planned well may be performed based on the historical information of the existing production well.

Examples of data analytics for oilfield data repositories in accordance with one or more embodiments are described in the following. In one or more embodiments, the examples described below may be practiced using the E&P computer system (218) described in reference to FIG. 1.2 and the method flowchart described in reference to FIGS. 2.1 and 2.2.

In general, the example includes a four-stage workflow to enable non-analysts to perform business analytics on E&P data sets available in oilfield data repositories. Dividing the process into four-stages is for example purposes. More or fewer stages may exist without departing from the scope of the claims.

Stage 1: Index the E&P data sets and collect digital fingerprints using various fingerprint algorithm to be analyzed by the analyst user.

Stage 2: Analyze the data set indices and digital fingerprints to build rule sets and qualified digital fingerprints.

Stage 3: Re-do indexing from Stage 1, but include the rules and digital fingerprints created in Stage 2 to provide additional information in the data set indices.

Stage 4: A less knowledgeable user uses a search tool to perform various searches. For example, the less knowledgeable user may search for known desired or undesired outcomes using a rule-based search input, such as “Where can I find water kick related information compiled from previous drillings through the same environment as my current well?”

In another example, the less knowledgeable user may search for similar historical situations to assess unknown risks or opportunities for his/her current project, using digital-fingerprint-based search input such as “Where can find seismic with the same signal fingerprint as this area of interest for the current project?”

A set of simplified rules and fingerprints are described below as an example of the four-stage workflow.

In Stage 1, the E&P data sets are indexed. TABLE 1 shows the resultant E&P data set indices.

TABLE 1

| Well Name | Has water kick? | Pressure |
|---|---|---|
| Well A | Yes | 6 |
| Well B | Yes | 7 |
| Well C | No | 2 |

In the first part of Stage 2, the E&P data sets are analyzed to generate a rule. For example, the analyst user selects the E&P data sets of wells with water kick as the training data collection for generating the WaterKickPressureRule. The resultant WaterKickPressureRule stipulates that wells with water kick have more than 5 in pressure. The WaterKickPressureRule may be stored in a data structure suitable for execution by a computer processor.

In the second part of Stage 2, the E&P data sets are analyzed to generate fingerprints. For example, the analyst user selects the E&P data sets of wells with water kick as the training data collection to determine an appropriate algorithm for generating fingerprints. Accordingly, the analyst user uses various fingerprint algorithms to extract various types of fingerprints and select the appropriate algorithm that generates fingerprints correlating consistently with the existence or absence of the water kick phenomenon of the wells. The resultant fingerprint is referred to as the GammaRayFingerprint. Based on the GammaRayFingerprint, a rule is generated that is referred to as the WaterKickGammaRayFingerprintRule, which stipulates that wells with water kick have GammaRay fingerprint starting with 7ABC.

In Stage 3, the E&P data set indices are augmented with the

GammaRayFingerprint and the results of applying the WaterKickPressureRule and the WaterKickGammaRayFingerprintRule. TABLE 2 shows the resultant augmented E&P data set indices.

TABLE 2

| | | | | | Water |
|---|---|---|---|---|---|
| | | | | | Kick |
| | | | | | Gamma |
| | | | Water Kick | Gamma | Ray |
| Well | Kick | | Pressure | Ray | Fingerprint |
| Name | Pressure | Pressure | Rule | Fingerprint | Rule |
| Well A | Yes | 6 | Yes | 7ABC-9876 | Yes |
| Well B | Yes | 7 | Yes | 7ABC-1231 | Yes |
| Well C | No | 2 | No | 123C-902A | No |
| Well D | No | 3 | No | 123C-9281 | No |
| Well E | | Unknown | Yes | 7ABC-389A | Yes |

In one example of Stage 4, the less knowledgeable user knows that there is a chance of water kick of the well he/she plans to drill. The less knowledgeable user explicitly searches for wells likely to have water kick, using the search input “show me all wells likely to have water kick.” The search is performed based on the WaterKickPressureRule to identify wells A, B, and E. Accordingly, E&P data sets associated with wells A, B, and E are retrieved.

In another example of Stage 4, the less knowledgeable user wants to know what he/she might or might not expect based on data that is similar to his/her current project. The less knowledgeable user searches the E&P data sets using the search input “show me wells that are similar to the one I am drilling.” The search is performed by extracting the GammaRay Fingerprint from the current well, to be “123C-AB19”. The E&P data sets are further searched for best matches of the GammaRay Fingerprint “123C-AB19”. Well C and well D rank the highest. Because both well C and well D do not match the WaterKickPressureRule, the less knowledgeable user concludes that water kick is unlikely for his/her current project.

Additional example of E&P data sets and data set indices for the field object “Well A” are described below in TABLES 3-8.

TABLE 3 shows a portion of the E&P data sets associated with “Well A”. In particular, the portion may include an E&P data set (referred to as “Well A data set”) that includes a well document “Well A”, a logs document “GammaRay”, and two events documents “Circulating” and “Waterkick”.

TABLE 3

| | | |
|---|---|---|
| Well: | Name: | Well A |
| | Time Series: | [10:00, 10:15, 10:30, |
| | | 10:45, 11:00, 11:15, 11:30] |
| | Pressure Series: | [3, 4, 6, 6, 5, 2, 1] |
| Logs: | Name: | GammaRay |
| | Depth: | [123, 124, 125, 126, 127, |
| | | 128, 129] |
| | Value: | [112.0, 109.2, 107.8, 65.4, |
| | | 66.6, 69.8, 109.1] |
| Events: | | |
| Event 1: | Name: | Circulating |
| | Timestamp: | 10:00 |
| | Description: | Circulating mud. |
| Event 2: | Name: | Waterkick |
| | Timestamp: | 10:35 |
| | Description: | Observed a mild water |
| | | kick when entering a |
| | | new formation. |

TABLES 4 and 5 show two given functions and an index transform algorithm used for generating the E&P indices augmented with digital fingerprint.

TABLE 4

| | | |
|---|---|---|
| Given | Max(series): | Returns the maximum |
| functions: | | of a number series |
| | ExtractFingerPrint(depths, values): | Extracts fingerprint |
| | | from multidimensional |
| | | data series. |

TABLE 5

| | | |
|---|---|---|
| index | Name: | Well.Name |
| transform | Max Pressure: | Max(Well.PressureSeries) => 6 |
| algorithm | Has Water | Events has event with name ‘Waterkick’ => |
| to | Kick: | Yes |
| generate a | Gamma Ray | ExtractFingerPrint(Logs.GammaRay.Depth, |
| index | Fingerprint: | Logs.GammaRay.Value) => 7ABC-9876 |
| record: | | |

TABLE 6 shows the example augmented E&P indices for “Well A data set” with digital fingerprint.

TABLE 6

| | |
|---|---|
| Name: | Well A |
| Max Pressure: | 6 |
| Has Water Kick: | Yes |
| Gamma Ray Fingerprint: | 7ABC-9876 |

TABLE 7 shows additional rules for further augmenting the E&P data indices.

TABLE 7

| | |
|---|---|
| Water Kick | ApplyRule(WaterKickPressureRule, |
| Pressure Rule: | Max(Well.PressureSeries)) |
| Water Kick | ApplyRule(WaterKickGammaRayFingerprintRule, |
| Gamma Ray | ExtractFingerPrint(Logs.GammaRay.Depth, |
| Fingerprint Rule: | Logs.GammaRay.Value)) |

TABLE 8 shows the example augmented E&P data indices for “Well A data set” with digital fingerprint and results of applying the rules.

TABLE 8

| | |
|---|---|
| Name: | Well A |
| Max Pressure: | 6 |
| Has Water Kick: | Yes |
| Gamma Ray Fingerprint: | 7ABC-9876 |
| Water Kick Pressure Rule: | Yes |
| Water Kick Gamma Ray Fingerprint Rule: | Yes |

Embodiments of data analytics for oilfield data repositories may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of data analytics for oilfield data repositories. For example, as shown in FIG. 3, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device. The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of data analytics for oilfield data repositories may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of data analytics for oilfield data repositories.

Further, one or more elements of the aforementioned computing system (400) may be located at a remote location and connected to the other elements over a network (412). Further, embodiments of data analytics for oilfield data repositories may be implemented on a distributed system having a plurality of nodes, where each portion of data analytics for oilfield data repositories may be located on a different node within the distributed system. In one embodiment of data analytics for oilfield data repositories, the node corresponds to a distinct computing device. The node may correspond to a computer processor with associated physical memory. The node may correspond to a computer processor or micro-core of a computer processor with shared memory and/or resources.

The systems and methods provided relate to the acquisition of hydrocarbons from an oilfield. It will be appreciated that the same systems and methods may be used for performing subsurface operations, such as mining, water retrieval, and acquisition of other underground fluids or other geomaterials from other fields. Further, portions of the systems and methods may be implemented as software, hardware, firmware, or combinations thereof.

While data analytics for oilfield data repositories has been described with respect to a limited number of embodiments, those skilled in the art, having benefit of this disclosure, will appreciate that other embodiments can be devised which do not depart from the scope of data analytics for oilfield data repositories as disclosed herein. Accordingly, the scope of data analytics for oilfield data repositories should be limited by the attached claims.

What is claimed is:

1. A method for field management, comprising:
analyzing a plurality of exploration and production (E&P) data sets to generate a plurality of digital fingerprints of the plurality of E&P data sets, wherein each of the plurality of digital fingerprints represents a statistical characteristic of an E&P data set of the plurality of E&P data sets;
augmenting, by a computer processor, a plurality of data set indices of the plurality of E&P data sets based on the plurality of digital fingerprints to generate a plurality of augmented data set indices;
retrieving, in response to a user search input and using the plurality of augmented data set indices, a selected E&P data set from the plurality of E&P data sets; and
presenting the selected E&P data set.

2. The method of claim 1, further comprising:
analyzing the plurality of E&P data sets to generate a plurality of rules, wherein each of the plurality of rules is based on an empirical statistic of a plurality of field objects in the field; and
further augmenting the plurality of data set indices based on the plurality of rules to generate the plurality of augmented data set indices.

3. The method of claim 2, further comprising:
extracting, based on a training data collection criterion, a portion of the plurality of E&P data sets as a training data collection; and
receiving, from an analyst user and based on the training data collection, an analyst user input selecting a fingerprint algorithm from a plurality of fingerprint algorithms,
wherein at least one of the plurality of digital fingerprints is generated using the fingerprint algorithm.

4. The method of claim 3, wherein generating the plurality of rules comprises:
analyzing the training data collection with respect to the plurality of field objects to generate the empirical statistic based on the plurality of digital fingerprints,
wherein the plurality of field objects comprise a plurality of geological structures and a plurality of wells, and
wherein the plurality of rules comprise at least one rule based on the training data collection criterion and the empirical statistic.

5. The method of claim 3, wherein generating the plurality of rules comprise:
analyzing the training data collection with respect to the plurality of field objects to generate the empirical statistic based on an attribute associated with each of the plurality of field objects,
wherein the plurality of field objects comprise the plurality of geological structures and the plurality of wells, and
wherein the plurality of rules comprise at least one rule based on the training data collection criterion and the empirical statistic.

6. The method of claim 1, wherein augmenting the plurality of data set indices comprises:
tagging each of the plurality of E&P data sets, with a corresponding digital fingerprint of the plurality of digital fingerprints, to generate a plurality of tagged E&P data sets,
wherein the plurality of augmented data set indices are generated based on the plurality of tagged E&P data sets.

7. The method of claim 2, wherein augmenting the plurality of data set indices comprises:
identifying a rule of the plurality of rules;
tagging each of the plurality of E&P data sets, with a corresponding result of applying the rule, to generate a plurality of tagged E&P data sets,
wherein the plurality of augmented data set indices are generated based on the plurality of tagged E&P data sets.

8. A system for field management, comprising:
an exploration and production (E&P) tool executing on a computer processor and configured to perform E&P activities in the field, the E&P tool comprising:
an E&P data set indexing engine configured to:
analyze a plurality of E&P data sets to generate a plurality of data set indices for the plurality of E&P data sets;
further analyze the plurality of E&P data sets to generate a plurality of digital fingerprints of the plurality of E&P data sets, wherein each of the plurality of digital fingerprints represents a statistical characteristic of an E&P data set of the plurality of E&P data sets; and
augment the plurality of data set indices based on the plurality of digital fingerprints to generate a plurality of augmented data set indices;
an E&P data set search engine executing on the computer processor and configured to:
retrieve, in response to a user search input and using the plurality of augmented data set indices, a selected E&P data set from the plurality of E&P data sets; and
an E&P task engine executing on the computer processor and configured to:
perform a field operation based on the selected E&P data set; and
a repository coupled to the computer processor and configured to store the plurality of E&P data sets and the plurality of augmented data set indices.

9. The system of claim 8, further comprising:
a plurality of data acquisition tools disposed in the field and configured to generate the plurality of E&P data sets for a plurality of field objects in the field,
wherein the E&P data set indexing engine is further configured to:
analyze the plurality of E&P data sets to generate a plurality of rules, wherein each of the plurality of rules is based on an empirical statistic of the plurality of field objects; and
further augment the plurality of data set indices based on the plurality of rules to generate the plurality of augmented data set indices.

10. The system of claim 9, wherein the E&P data set indexing engine is further configured to:
extract, based on a training data collection criterion, a portion of the plurality of E&P data sets as a training data collection, wherein the plurality of E&P data sets are stored in a plurality of data repositories; and
receive, from an analyst user and based on the training data collection, an analyst user input selecting a fingerprint algorithm from a plurality of fingerprint algorithms,
wherein at least one of the plurality of digital fingerprints is generated using the fingerprint algorithm.

11. The system of claim 10, wherein generating the plurality of rules comprise:
analyzing the training data collection with respect to the plurality of field objects to generate the empirical statistic based on the plurality of digital fingerprints,
wherein the plurality of field objects comprise a geological structure and a well, and
wherein the plurality of rules comprise at least one rule based on the training data collection criterion and the empirical statistic.

12. The system of claim 10, wherein generating the plurality of rules comprises:
analyzing the training data collection with respect to the plurality of field objects to generate the empirical statistic based on an attribute associated with each of the plurality of field objects,
wherein the plurality of field objects comprise a geological structure and a well, and
wherein the plurality of rules comprise at least one rule based on the training data collection criterion and the empirical statistic.

13. The system of claim 8, wherein augmenting the plurality of data set indices comprises:
tagging each of the plurality of E&P data sets, with a corresponding digital fingerprint of the plurality of digital fingerprints, to generate a plurality of tagged E&P data sets,
wherein the plurality of augmented data set indices are generated based on the plurality of tagged E&P data sets.

14. The system of claim 9, wherein augmenting the plurality of data set indices comprises:
identifying a rule of the plurality of rules;
tagging each of the plurality of E&P data sets, with a corresponding result of applying the rule, to generate a plurality of tagged E&P data sets,
wherein the plurality of augmented data set indices are generated based on the plurality of tagged E&P data sets.

15. A non-transitory computer readable medium comprising instructions to perform field management, the instructions when executed by a computer processor comprising functionality for:
analyzing a plurality of exploration and production (E&P) data sets to generate a plurality of digital fingerprints of the plurality of E&P data sets, wherein each of the plurality of digital fingerprints represents a statistical characteristic of an E&P data set of the plurality of E&P data sets;
augmenting a plurality of data set indices of the plurality of E&P data sets based on the plurality of digital fingerprints to generate a plurality of augmented data set indices;
retrieving, in response to a user search input and using the plurality of augmented data set indices, a selected E&P data set from the plurality of E&P data sets; and
presenting the selected E&P data set.

16. The non-transitory computer readable medium of claim 15, the instructions when executed by the computer processor further comprising functionality for:
analyzing the plurality of E&P data sets to generate a plurality of rules, wherein each of the plurality of rules is based on an empirical statistic of a plurality of field objects in the field; and
further augmenting the plurality of data set indices based on the plurality of rules to generate the plurality of augmented data set indices.

17. The non-transitory computer readable medium of claim 16, the instructions when executed by the computer processor further comprising functionality for:
extracting, based on a training data collection criterion, a portion of the plurality of E&P data sets as a training data collection, wherein the plurality of E&P data sets are stored in a plurality of data repositories; and
receiving, from an analyst user and based on the training data collection, an analyst user input selecting a fingerprint algorithm from a plurality of fingerprint algorithms, wherein at least one of the plurality of digital fingerprints is generated using the fingerprint algorithm.

18. The non-transitory computer readable medium of claim 17, wherein generating the plurality of rules comprise:
analyzing the training data collection with respect to the plurality of field objects to generate the empirical statistic based on the plurality of digital fingerprints,
wherein the plurality of field objects comprise a plurality of geological structures and a plurality of wells, and
wherein the plurality of rules comprise at least one rule based on the training data collection criterion and the empirical statistic.

19. The non-transitory computer readable medium of claim 15, wherein augmenting the plurality of data set indices comprises:
tagging each of the plurality of E&P data sets, with a corresponding digital fingerprint of the plurality of digital fingerprints, to generate a plurality of tagged E&P data sets,
wherein the plurality of augmented data set indices are generated based on the plurality of tagged E&P data sets.

20. The non-transitory computer readable medium of claim 16, wherein augmenting the plurality of data set indices comprises:
identifying a rule of the plurality of rules;
tagging each of the plurality of E&P data sets, with a corresponding result of applying the rule, to generate a plurality of tagged E&P data sets,
wherein the plurality of augmented data set indices are generated based on the plurality of tagged E&P data sets.
